(19) United States
(12) Patent Application Publication
(10) Pub. No.: US 2003/0231153 A1
(43) Pub. Date: Dec. 18, 2003

(54) LCD source driver integrated circuit using separate R, G, B gray scale voltages

(75) Inventors: Si-wang Seong, Suwon-city (KR); Sang-ho Park, Suwon-city (KR)

Correspondence Address: Steven M. Mills, MILLS & ONELLO LLP, Eleven Beacon Street, Suite 605, Boston, MA, 02108, US

(73) Assignee: Samsung Electronics Co., Ltd.

(21) Appl. No.: 10/452,747

(22) Filed: Jun. 2, 2003

(30) Foreign Application Priority Data
Jun. 14, 2002 (KR) 02-33348

(51) Int. Cl. G09G 3/36

(52) U.S. Cl. 345/88; 345/89

(57) ABSTRACT

A source driver integrated circuit (IC) for driving an LCD which uses separate gray scale voltages for red (R), green (G), and blue (B) is provided. The source driver IC comprises: an R gray scale voltage generation circuit which generates a plurality of R gray scale voltages; a G gray scale voltage generation circuit which generates a plurality of G gray scale voltages; a B gray scale voltage generation circuit which generates a plurality of B gray scale voltages; an R decoder which selects one of the plurality of R gray scale voltages in response to R input data and outputs the selected voltage; a G decoder which selects one of the plurality of G gray scale voltages in response to G input data and outputs the selected voltage; and a B decoder which selects one of the plurality of B gray scale voltages in response to B input data and outputs the selected voltage, wherein the layout regions for the R, G, and B decoders are separated for R, G, and B, respectively.

### BACKGROUND OF THE INVENTION

1. Field of the Invention

The present invention relates to a display apparatus, and more particularly, to a layout of a source driver integrated circuit (IC) for driving a display panel, the source driver IC generating separate voltages for red (R), green (G), and blue (B).

2. Description of the Related Art

A thin film transistor (TFT)-liquid crystal display (LCD) is a display apparatus which is widely employed in notebook computers and monitors, especially as a color display apparatus.

A color LCD screen expresses a color by combining colors passing through R, G, and B color filters. A voltage which is provided to a source electrode in order to express each of R, G, and B colors is referred to as a gray scale voltage and is output from a source driver IC for driving a display panel. The brightness of a color varies with the gray scale voltage.

In the prior art, however, each of the R, G, and B voltages is generated in an identical gray scale voltage generation circuit. That is, a gray scale voltage generation circuit generates identical gray scale voltages without distinguishing among R, G, and B. This assumes that the electro-optical characteristics of respective pixels of R, G, and B, that is, their luminance characteristics with respect to applied voltage, are the same. However, the luminance characteristics of the respective pixels of R, G, and B with respect to applied voltage are actually different. That is, the respective luminance characteristics of R, G, and B at an identical gray scale voltage are not the same. Due to these differences, G-white, or R-black scene problems in which G or R is seen only slightly when a white or black scene is output occur.

Therefore, in order to solve the problem, a different gray scale voltage is needed for each of R, G, and B. When a method in which a gray scale voltage for each of R, G, and B is separately generated is employed, the number of wiring lines for gray scale voltages in the same space triples in the layout of the prior art source driver IC such that the chip size of the IC increases greatly.

Therefore, a layout method in which separate gray scale voltages are used for R, G, and B without increasing the chip size of the source driver IC is needed.

### SUMMARY OF THE INVENTION

To solve the above problems, it is an objective of the present invention to provide a source driver IC which uses separate gray scale voltages for R, G, and B while minimizing an increase of the chip size.

According to an aspect of the present invention, there is provided a source driver integrated circuit (IC) for driving a liquid crystal display (LCD) comprising R decoders arranged in an R decoder region, each R decoder selecting one of a plurality of R gray scale voltages in response to R input data and outputting the selected R gray scale voltage, G decoders arranged in a G decoder region, each G decoder selecting one of a plurality of G gray scale voltages in response to G input data and outputting the selected G gray scale voltage, B decoders arranged in a B decoder region, each of B decoder selecting one of a plurality of B gray scale voltages in response to B input data and outputting the selected B gray scale voltage, an R gray scale voltage generation circuit which is arranged in the R decoder region and generates the plurality of R gray scale voltages, a G gray scale voltage generation circuit which is arranged in the G decoder region and generates the plurality of G gray scale voltages and a B gray scale voltage generation circuit which is arranged in the B decoder region and generates the plurality of B gray scale voltages, wherein the R, G, and B decoder regions are separated from each other.

In one embodiment of the source driver IC, the R, G, and B gray scale voltage generation circuits are placed at the substantial center of the R, G, and B decoder regions, respectively. Alternatively, the R, G, and B gray scale voltage generation circuits can be placed at the substantial edge of the R, G, and B decoder regions, respectively.

According to another aspect of the present invention, there is provided a source driver IC for driving a liquid crystal display (LCD) comprising an R gray scale voltage generation circuit which generates a plurality of R gray scale voltages, a G gray scale voltage generation circuit which generates a plurality of G gray scale voltages, a B gray scale voltage generation circuit which generates a plurality of B gray scale voltages, an R decoder which selects one of the plurality of R gray scale voltages in response to R input data and outputs the selected R gray scale voltage, a G decoder which selects one of the plurality of G gray scale voltages in response to G input data and outputs the selected G gray scale voltage and a B decoder which selects one of the plurality of B gray scale voltages in response to B input data and outputs the selected B gray scale voltage, wherein the layout regions for the R, G, and B decoders are respectively separated.

In one embodiment, wiring for the R gray scale voltages does not pass the layout regions of the G and B decoders, wiring for the G gray scale voltages does not pass the layout regions of the R and B decoders, and wiring for the B gray scale voltage does not pass the layout regions of the R and G decoders.

The source driver IC can also include an amplification unit which buffers or amplifies the selected R, G, B gray scale voltages.

### BRIEF DESCRIPTION OF THE DRAWINGS

The foregoing and other objects, features and advantages of the invention will be apparent from the more particular description of a preferred embodiment of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of the layout of a source driver IC according to a preferred embodiment of the present invention.

FIG. 2 is a diagram of an example layout of a conventional source driver IC for comparison to FIG. 1.

### DESCRIPTION OF THE PREFERRED EMBODIMENTS

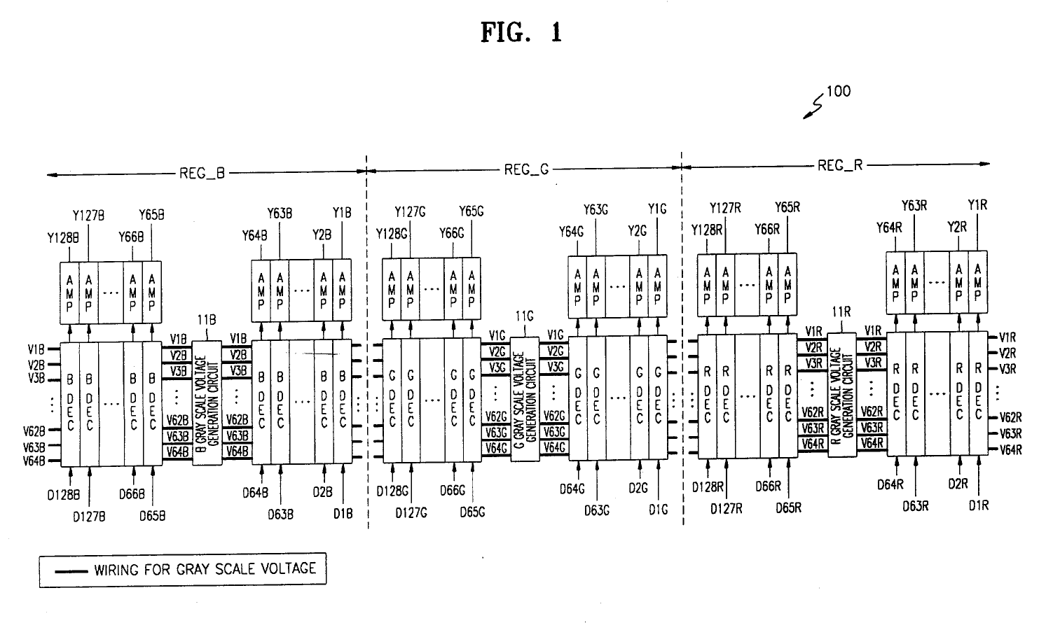

Referring to FIG. 1, a source driver IC 100 according to a preferred embodiment of the present invention comprises an R gray scale voltage generation circuit (11R), a G gray scale voltage generation circuit (11G), a B gray scale voltage generation circuit (11B), an R decoder (R DEC), a G decoder (G DEC), and a B decoder (B DEC).

The R gray scale voltage generation circuit (11 R) generates a plurality of R gray scale voltages (ViR, i=1˜64) using a plurality of reference voltages. Likewise, the G gray scale voltage generation circuit (11G) generates a plurality of G gray scale voltages (ViG, i=1˜64) and the B gray scale voltage generation circuit (11B) generates a plurality of B gray scale voltages (ViB, i=1˜64). Each of the gray scale voltage generation circuits (11R, 11G, 11B) distributes reference voltages using a plurality of resistors (not shown) that are serially connected, so that gray scale voltages (ViR, ViG, ViB, i=1˜64) are generated. In the present embodiment, each of the R, G, and B gray scale voltage generation circuits generates 64 gray scale voltages (ViR, ViG, ViB, i=1˜64).

Each of the decoders (R, G, B DECs) in response to digital data (DiR, DiG, DiB, i=1˜128) being input selects one of the 64 gray scale voltages (ViR, ViG, ViB, i=1˜64).

Accordingly, it is preferable that the number of decoders (R, G, B DECs) is the same as the number of signals that are output at the same time. In the present embodiment, it is assumed that one line of an LCD panel is formed by 128 pixels. Since three output signals of R, G, and B are needed to express a pixel, a total of 384 output signals of R, G, and B (YiR, YiG, YiB, i=1˜64) are needed to express one line. In order to generate 384 output signals of R, G, and B (YiR, YiG, YiB, i=1˜64), 384 input data signals (DiR, DiG, DiB, i=1˜64) are needed. R, G, B input data signals (DiR, DiG, DiB, i=1˜64) are digital signals input from a microprocessor (not shown). Therefore, it is preferable that in order to select any one of the 64 gray scale voltages, each of R, G, B input data signals (DiR, DiG, DiB, i=1˜64) is a 6 bits long digital signal.

Each of 128 R decoders (R DECs) selects one of 64 R gray scale voltages. (ViR, i=1˜64) in response to R input data signals (DiR, i=1˜128) and outputs the selected voltage. Likewise, each of 128 G decoders (G DECs) selects one of 64 G gray scale voltages (ViG, i=1˜64) in response to G input data signals (DiG, i=1˜128) and outputs the selected voltage, and each of 128 B decoders (B DECs) selects one of 64 B gray scale voltages (ViB, i=1˜64) in response to B input data signals (DiB, i=1˜128) and outputs the selected voltage.

It is preferable that the source driver IC 100 according to the preferred embodiment of the present invention further comprises amplifying units (AMPs) which buffer or amplify the output signals of the R, G, B decoders (R, G, B DECs). The output signals (YiR, YiG, YiB, i=1˜128) of the amplifying units (AMPs) are provided to the LCD panel.

In the layout of the present embodiment, R, G, B decoders are separately arranged in different regions (REG_R, REG_G, REG_B), respectively. At the center of each of the regions (REG_R, REG_G, REG_B) where decoder units are placed, a corresponding gray scale voltage generation circuit (11R, 11G, 11B) is placed. More specifically, in one embodiment, the R gray scale voltage generation circuit (11R) is placed at the center of the R decoder unit formed by 128 R decoders (R DECs), the G gray scale voltage generation circuit (11G) is placed at the center of the G decoder unit formed by 128 G decoders (G DECs), and the B gray scale voltage generation circuit (11B) is placed at the center of the B decoder unit formed by 128 B decoders (B DECS),

As described above, by placing decoder units in respective separate regions (REG_R, REG_G, REG_B) and placing corresponding gray scale voltage generation circuits (11R, 11G, 11B) in respective regions (REG_R, REG_G, REG_B) where decoder units are formed, wiring for gray scale voltages which are generated in respective gray scale voltage generation circuits (REG_R, REG_G, REG_B) does not need to pass other decoder regions. That is, wiring for R gray scale voltages (ViR, i=1˜64) does not pass layout regions of G and B decoders (REG_G, REG_B), wiring for G gray scale voltages (ViG, i=1˜64) does not pass layout regions of R and B decoders (REG_R, REG_B), and wiring for B gray scale voltages (ViR, i=1˜64) does not pass layout regions of R and G decoders (REG_R, REG G).

Accordingly, even though separate gray scale voltages for R, G, and B are used, the chip size increases only by the two added gray scale voltage generation circuits, unlike the prior art chip which uses identical gray scale voltages without distinction among R, G, and B.

In the present embodiment, the gray scale voltage generation circuits (11R, 11G, 11B) are placed at the centers of respective decoder regions (REG_R, REG_G, REG_B). Alternatively, the gray scale voltage generation circuits (11R, 11G, 11B) may be placed at edges of respective decoder regions (REG_R, REG_G, REG_B). Accordingly, it is clear to a person skilled in the art that a variety of layout methods are possible in which R, G, and B decoders are arranged separately so that wiring for gray scale voltages generated in each gray scale voltage generation circuits (11R, 11G, 11B) does not need to pass other decoder areas, and corresponding gray scale voltage generation circuits are arranged in respective decoder regions.

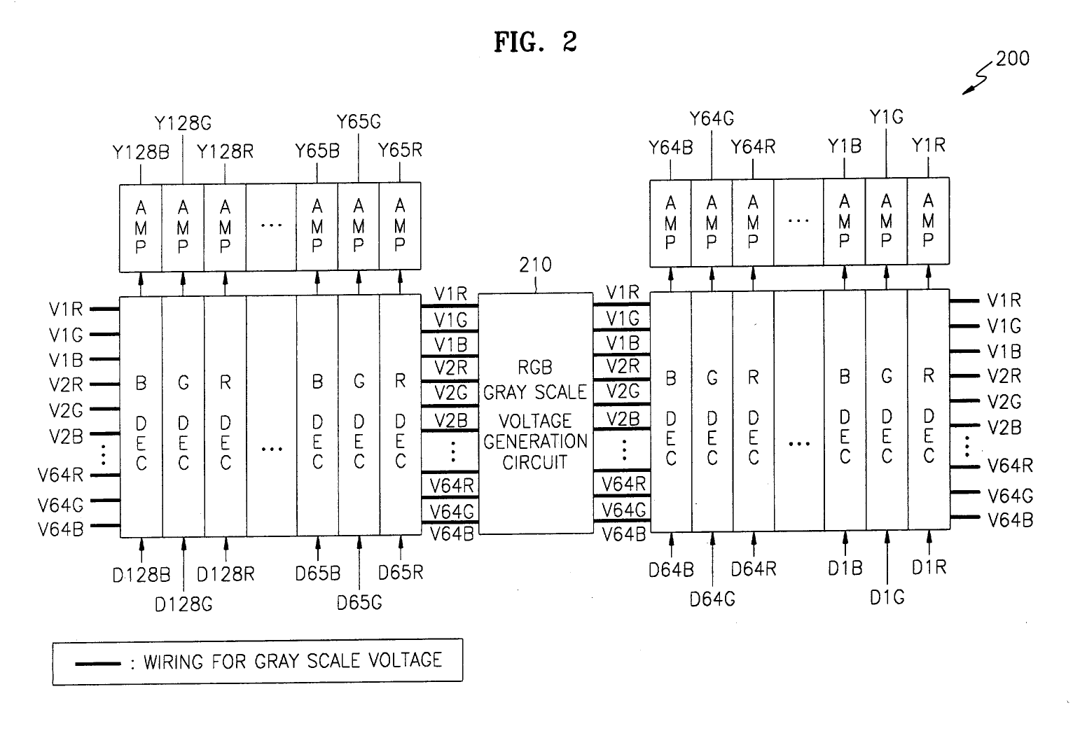

FIG. 2 is a diagram of an example layout of a source driver IC for comparison with the above-described embodiment of the present invention. Referring to FIG. 2, the example source driver IC 200 comprises an RGB gray scale voltage generation circuit 210, decoder units (R, G, B DECs), and amplification units (AMPs).

In the example layout shown in FIG. 2, decoders are not placed in separate R, G, and B regions. That is, in FIG. 2, decoders (R, G, B DECs) generating 128 R, G, B output signals (YiR, YiG, YiB, i=1˜128) are arranged in order of R, G, and B. The RGB gray scale voltage generation circuit 210 generating R gray scale voltages (ViR, i=1˜64), G gray scale voltages (ViG, i=1˜64), and B gray scale voltages (ViB, i=1˜64) is placed at the center of a region where decoders (R, G, B DECs) are arranged.

If in FIG. 2 each of the numbers of R gray scale voltages (ViR, i=1˜64), G gray scale voltages (ViG, i=1˜64), and B gray scale voltages (ViB, i=1˜64) is 64, the total number of gray scale voltages generated from the RGB gray scale voltage generation circuit 210 is 192. As wiring for 192 gray scale voltages (ViR, ViG, ViB, i=1˜64), 192 gray scale voltage wiring lines should be formed connecting the region where the decoders (R, G, B DECs) are arranged.

Each of R decoders (R DECs) selects one of 64 R gray scale voltages (ViR, i=1˜64) in response to R input data (DiR, i=1˜128) and outputs the selected voltage. Each of G decoders (G DECs) selects one of 64 G gray scale voltages (ViG, i=1˜64) in response to G input data (DiG, i=1˜128) and outputs the selected voltage. Each of B decoders (B DECs) selects one of 64 B gray scale voltages (ViB, i=1˜64) in response to B input data (DiB, i=1˜128) and outputs the selected voltage. Accordingly, gray scale voltages are input to respective R, G, B decoders (R, G, B DECs), but, if the decoders (R, G, B DECs) and the RGB gray scale voltage generation circuit.210 are arranged in the layout method shown in FIG. 2, lines for a total of 192 gray scale voltages should be formed connecting the decoder region.

Therefore, the number of gray scale voltage lines passing the decoder region in FIG. 2 is three times as many as the number of lines needed in a source driver IC using one gray scale voltage generation circuit that generates identical gray scale voltages for R, G, and B. Accordingly, due to the wiring lines for gray scale voltages, the size of the layout area of the source driver IC increases and the lines for gray scale voltages may overlap neighboring lines.

According to the present invention, separate gray scale voltages for R, G, and B are used while minimizing an increase of the chip size.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A source driver integrated circuit (IC) for driving a liquid crystal display (LCD) comprising:
Red (R) decoders arranged in an R decoder region, each R decoder selecting one of a plurality of R gray scale voltages in response to R input data and outputting the selected R gray scale voltage;
Green(G) decoders arranged in a G decoder region, each G decoder selecting one of a plurality of G gray scale voltages in response to G input data and outputting the selected G gray scale voltage;
Blue (B) decoders arranged in a B decoder region, each B decoder selecting one of a plurality of B gray scale voltages in response to B input data and outputting the selected B gray scale voltage;
an R gray scale voltage generation circuit which is arranged in the R decoder region and generates the plurality of R gray scale voltages;
a G gray scale voltage generation circuit which is arranged in the G decoder region and generates the plurality of G gray scale voltages; and
a B gray scale voltage generation circuit which is arranged in the B decoder region and generates the plurality of B gray scale voltages,
wherein the R, G, and B decoder regions are separated from each other.

2. The source driver IC of claim 1, wherein the R, G, and B gray scale voltage generation circuits are placed at the substantial center of the R, G, and B decoder regions, respectively.

3. The source driver IC of claim 1, wherein the R, G, and B gray scale voltage generation circuits are placed at the substantial edge of the R, G, and B decoder regions, respectively.

4. The source driver IC of claim 1, further comprising:
an amplification unit which buffers or amplifies the selected R, G, B gray scale voltages.

5. A source driver IC for driving a liquid crystal display (LCD) comprising:
an R gray scale voltage generation circuit which generates a plurality of R gray scale voltages;
a G gray scale voltage generation circuit which generates a plurality of G gray scale voltages;
a B gray scale voltage generation circuit which generates a plurality of B gray scale voltages;
an R decoder which selects one of the plurality of R gray scale voltages in response to R input data and outputs the selected R gray scale voltage;
a G decoder which selects one of the plurality of G gray scale voltages in response to G input data and outputs the selected G gray scale voltage; and
a B decoder which selects one of the plurality of B gray scale voltages in response to B input data and outputs the selected B gray scale voltage,
wherein the layout regions for the R, G, and B decoders are respectively separated.

6. The source driver IC of claim 5, wherein wiring for the R gray scale voltages does not pass the layout regions of the G and B decoders, wiring for the G gray scale voltages does not pass the layout regions of the R and B decoders, and wiring for the B gray scale voltage does not pass the layout regions of the R and G decoders.

7. The source driver IC of claim 5, wherein the R gray scale voltage generation circuit is placed at the layout region for the R decoder, wherein the G gray scale voltage generation circuit is placed at the layout region for the G decoder, and wherein the B gray scale voltage generation circuit is placed at the layout region for the B decoder.

8. The source driver IC of claim 5, further comprising:
an amplification unit which buffers or amplifies the selected R, G, B gray scale voltages.
